(19) United States
(12) Patent Application Publication
(10) Pub. No.: US 2020/0381177 A1
(43) Pub. Date: Dec. 3, 2020

(54) IGNITION COIL DEVICE

(71) Applicant: Mitsubishi Electric Corporation, Tokyo (JP)

(72) Inventor: Takashi IDOGAWA, Tokyo (JP)

(73) Assignee: Mitsubishi Electric Corporation, Tokyo (JP)

(21) Appl. No.: 16/855,071

(22) Filed: Apr. 22, 2020

(30) Foreign Application Priority Data
May 27, 2019 (JP) 2019-098334

(51) Int. Cl. H01F 38/12; H01F 27/32; H01F 27/24

(52) U.S. Cl. CPC H01F 38/12; H01T 15/00; H01F 27/24; H01F 27/325

(57) ABSTRACT

An ignition coil device having a simplified configuration is obtained. The ignition coil device includes: a primary bobbin having a first outer side surface and a second outer side surface formed on an outer side with respect to the first outer side surface in a width direction of the ignition coil device; a first primary coil wound around the first outer side surface; and a second primary coil wound across the second outer side surface and an outer side surface of the first primary coil, the first primary coil being formed by solid coiling.

### BACKGROUND OF THE INVENTION

### 1. Field of the Invention

The present invention relates to an ignition coil device.

### 2. Description of the Related Art

Hitherto, there has been known an ignition coil device including a primary bobbin, a main primary coil, an insulating sheet, and a sub-primary coil. The main primary coil is provided on an outer side surface of the primary bobbin. The insulating sheet is formed into a square tube shape, and is provided on an outer side surface of the main primary coil. The sub-primary coil is provided on an outer side surface of the insulating sheet. With the sub-primary coil being provided on the outer side surface of the insulating sheet, the sub-primary coil is stably fixed to the primary bobbin (see, for example, WO 2017/006487 A1).

However, the insulating sheet is arranged between the main primary coil and the sub-primary coil. With this configuration, there has been a problem in that the number of components of the ignition coil device is increased.

### SUMMARY OF THE INVENTION

The present invention has been made to solve the above-mentioned problem, and has an object to provide an ignition coil device having a simplified configuration.

An ignition coil device according to at least one embodiment of the present invention includes: a primary bobbin having a first outer side surface and a second outer side surface formed on an outer side with respect to the first outer side surface in a width direction of the ignition coil device; a first primary coil wound around the first outer side surface; and a second primary coil wound across the second outer side surface and an outer side surface of the first primary coil, the first primary coil being formed by solid coiling.

According to the ignition coil device of the present invention, the simplified configuration can be provided.

### BRIEF DESCRIPTION OF THE DRAWINGS

FIG. 1 is a plan view for illustrating an ignition coil device according to a first embodiment of the present invention.

FIG. 2 is a sectional view for illustrating the ignition coil device illustrated in FIG. 1.

FIG. 3 is a front view for illustrating a primary bobbin illustrated in FIG. 2.

FIG. 4 is a sectional view for illustrating an ignition coil device according to a second embodiment of the present invention.

FIG. 5 is a front view for illustrating a primary bobbin illustrated in FIG. 4.

FIG. 6 is a plan view for illustrating the primary bobbin illustrated in FIG. 5.

FIG. 7 is a bottom view for illustrating the primary bobbin illustrated in FIG. 5.

FIG. 8 is a bottom view for illustrating a state in which a sub-primary coil is wound around the primary bobbin illustrated in FIG. 7.

FIG. 9 is a plan view for illustrating a modification example of the primary bobbin illustrated in FIG. 4.

FIG. 10 is a sectional view for illustrating a state in which a sub-primary coil and a main primary coil are wound around the primary bobbin illustrated in FIG. 9.

### DESCRIPTION OF THE EMBODIMENTS

### First Embodiment

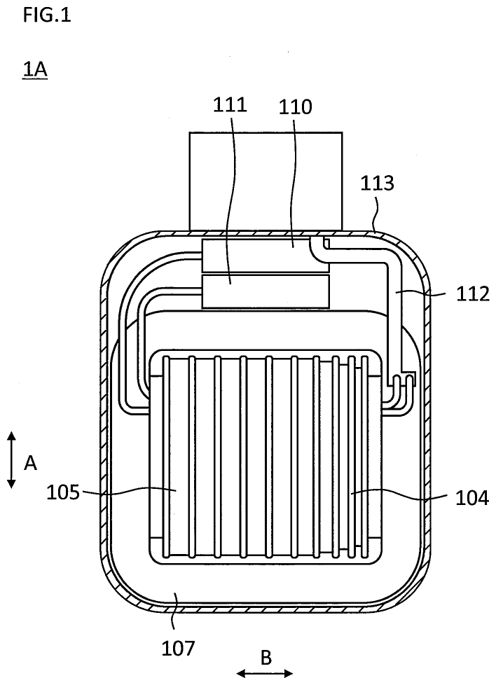

FIG. 1 is a plan view for illustrating an ignition coil device according to a first embodiment of the present invention.

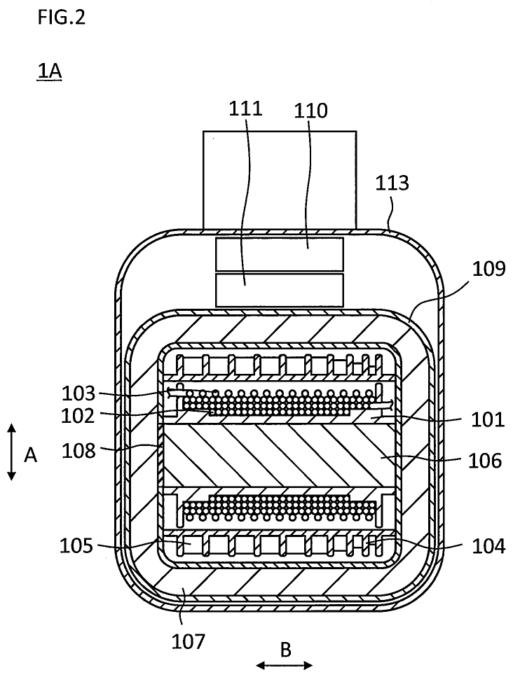

FIG. 2 is a sectional view for illustrating the ignition coil device illustrated in FIG. 1. In this example, an ignition coil device 1A to be mounted to an internal combustion engine is described. The ignition coil device 1A supplies electric energy to a spark plug (not shown). In the spark plug supplied with the electric energy from the ignition coil device LA, spark discharge occurs. The ignition coil device 1A may be mounted to devices other than the internal combustion engine.

The ignition coil device 1A includes a primary bobbin 101, a sub-primary coil 102 serving as a first primary coil, and a main primary coil 103 serving as a second primary coil. The sub-primary coil 102 and the main primary coil 103 are supported by the primary bobbin 101. The sub-primary coil 102 and the main primary coil 103 form a primary coil of the ignition coil device 1A.

In this example, a width direction A corresponds to a direction perpendicular to an axial line of the primary bobbin 101, and an axial direction B corresponds to a direction along the axial line of the primary bobbin 101. The main primary coil 103 is arranged on an outer side with respect to the sub-primary coil 102 in the width direction A.

The sub-primary coil 102 is formed by solid coiling. Solid coiling refers to winding a wire member forming the coil in a close-contact manner in the axial direction B. The sub-primary coil 102 is a single-layer coil. The main primary coil 103 is a three-layer coil. The number of turns of the sub-primary coil 102 is smaller than the number of turns of the main primary coil 103. The dimension of the sub-primary coil 102 in the axial direction B is smaller than the dimension of the main primary coil 103 in the axial direction B. A wire member forming each of the sub-primary coil 102 and the main primary coil 103 includes a conductive wire and an insulating film provided around the conductive wire.

Further, the ignition coil device 1A includes a secondary bobbin 104 and a secondary coil 105. The secondary bobbin 104 is arranged on an outer side with respect to the primary bobbin 101, the sub-primary coil 102, and the main primary coil 103 in the width direction A. The secondary coil 105 is supported by the secondary bobbin 104. The spark plug is electrically connected to one end portion of the secondary coil 105.

Further, the ignition coil device 1A includes a center core 106, a side core 107, a magnet 108, and a core cover 109. The center core 106 is arranged on an inner side with respect to the primary bobbin 101 in the width direction A. The side core 107 is arranged so as to surround the whole primary bobbin 101, sub-primary coil 102, main primary coil 103, secondary bobbin 104, and secondary coil 105. Further, the magnet 108 is arranged between one end portion of the center core 106 and the side core 107. The side core 107 is connected to another end portion of the center core 106. The core cover 109 is arranged around the side core 107.

By magnetically coupling the sub-primary coil 102, the main primary coil 103, the center core 106, the side core 107, and the magnet 108 to each other, electric energy for causing spark discharge in the spark plug can be generated in the secondary coil 105.

Further, the ignition coil device 1A includes a sub-IC 110, a main IC 111, a connection terminal 112, and a case 113. The sub-IC 110 is electrically connected to one end portion of the sub-primary coil 102. The sub-IC 110 controls a current to be supplied to the sub-primary coil 102. In other words, the sub-IC 110 supplies the current to the sub-primary coil 102 and also stops the current to be supplied to the sub-primary coil 102.

The main IC 111 is electrically connected to one end portion of the main primary coil 103. The main IC 111 controls a current to be supplied to the main primary coil 103. In other words, the main IC 111 supplies the current to the main primary coil 103 and also stops the current to be supplied to the main primary coil 103.

The connection terminal 112 is electrically connected to another end portion of the sub-primary coil 102 and another end portion of the main primary coil 103. Further, the connection terminal 112 is electrically connected to a battery (not shown). Therefore, a current is supplied from the connection terminal 112 to the sub-primary coil 102 and the main primary coil 103.

On an inner side of the case 113, the primary bobbin 101, the sub-primary coil 102, the main primary coil 103, the secondary bobbin 104, the secondary coil 105, the center core 106, the side core 107, the magnet 108, the core cover 109, the sub-IC 110, the main IC 111, and the connection terminal 112 are arranged. The inner side of the case 113 is potted with insulating resin.

The sub-primary coil 102 and the main primary coil 103 are wound in the same direction in a circumferential direction of the primary bobbin 101. The sub-primary coil 102 is wound around the primary bobbin 101 from one side toward another side in the axial direction B. Therefore, a winding start part of the sub-primary coil 102 is one side end portion of the sub-primary coil 102 in the axial direction B, that is, a left side end portion of the sub-primary coil 102 in FIG. 2. Meanwhile, a winding end part of the sub-primary coil 102 is another side end portion of the sub-primary coil 102 in the axial direction B, that is, a right side end portion of the sub-primary coil 102 in FIG. 2. After the sub-primary coil 102 is wound around the primary bobbin 101, the another end portion of the sub-primary coil 102 is connected to the connection terminal 112.

A winding start part of the main primary coil 103 is another side end portion of the main primary coil 103 in the axial direction B, that is, a right side end portion of the main primary coil 103 in FIG. 2. After the sub-primary coil 102 is wound around the primary bobbin 101, the main primary coil 103 is successively wound around the primary bobbin 101. A winding end part of the main primary coil 103 is one side end portion of the main primary coil 103 in the axial direction B, that is, a left side end portion of the main primary coil 103 in FIG. 2.

The another end portion of the sub-primary coil 102 and the another end portion of the main primary coil 103 are electrically connected to the battery via the connection terminal 112. Therefore, in the circumferential direction of the primary bobbin 101, a direction of a current flowing through the sub-primary coil 102 and a direction of a current flowing through the main primary coil 103 differ from each other. Further, a direction of an energizing magnetic flux, which is a magnetic flux to be generated when a current is supplied to the main primary coil 103, and a direction of a superposing magnetic flux, which is a magnetic flux to be generated when a current is supplied to the sub-primary coil 102, differ from each other. Meanwhile, a direction of an interrupting magnetic flux, which is a magnetic flux to be generated when a current flowing through the main primary coil 103 is stopped, and the direction of the superposing magnetic flux, which is to be generated when a current is supplied to the sub-primary coil 102, are the same.

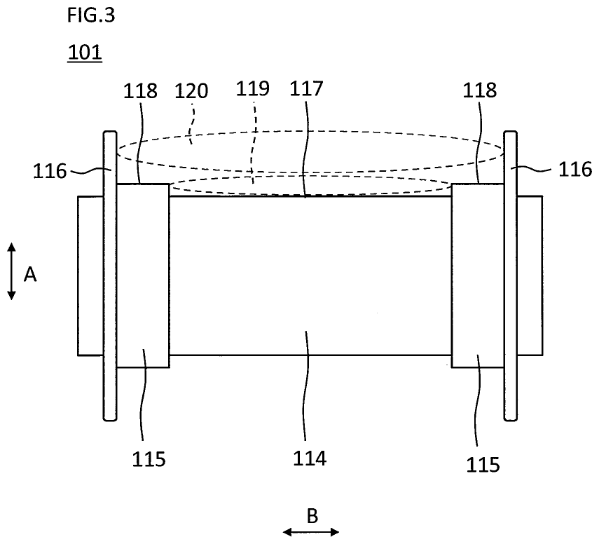

FIG. 3 is a front view for illustrating the primary bobbin 101 illustrated in FIG. 2. The primary bobbin 101 includes a first bobbin portion 114, a pair of second bobbin portions 115 provided adjacent to both end portions of the first bobbin portion 114 in the axial direction B, and a pair of flange portions 116 provided to the pair of second bobbin portions 115 in a one-to-one correspondence. The first bobbin portion 114 is arranged so as to be sandwiched between the pair of second bobbin portions 115 in the axial direction B. The first bobbin portion 114 and the pair of second bobbin portions 115 are arranged so as to be sandwiched between the pair of flange portions 116 in the axial direction B.

The first bobbin portion 114 is formed into a square tube shape. The first bobbin portion 114 has a first outer side surface 117. The second bobbin portion 115 is formed into a square tube shape. The second bobbin portion 115 has a second outer side surface 118. The second outer side surface 118 is arranged on an outer side with respect to the first outer side surface 117 in the width direction A.

An inner side surface of the first bobbin portion 114 and an inner side surface of the second bobbin portion 115 are, when viewed in the axial direction B, arranged so as to be flush with each other. The dimension of the second bobbin portion 115 in the width direction A is larger than the dimension of the first bobbin portion 114 in the width direction A. In other words, the second bobbin portion 115 is formed to have a larger dimension in a thickness direction than that of the first bobbin portion 114.

Around the first outer side surface 117, the sub-primary coil 102 is wound. A region partitioned by the first outer side surface 117 and surfaces of the pair of second bobbin portions 115 facing each other in the axial direction B is referred to as “sub-primary coil arrangement region 119”. In the sub-primary coil arrangement region 119, the sub-primary coil 102 is arranged. The sub-primary coil 102 is sandwiched between the pair of second bobbin portions 115 in the axial direction B so that the movement of the sub-primary coil 102 in the axial direction B is limited. Because the sub-primary coil 102 is formed by solid coiling, and the movement of the sub-primary coil 102 in the axial direction B is limited, the sub-primary coil 102 is fixed to the primary bobbin 101.

The main primary coil 103 is wound across the second outer side surfaces 118 and an outer side surface of the sub-primary coil 102. The outer side surface of the sub-primary coil 102 refers to an outer side surface of the sub-primary coil 102 in a case in which the sub-primary coil 102 is viewed in the axial direction B.

A region partitioned by the second outer side surfaces 118, the outer side surface of the sub-primary coil 102, and surfaces of the pair of flange portions 116 facing each other in the axial direction B is referred to as a “main primary coil arrangement region 120”. In the main primary coil arrangement region 120, the main primary coil 103 is arranged. The second outer side surfaces 118 and the outer side surface of the sub-primary coil 102 are arranged to be flush with each other when viewed in the axial direction B. In other words, the second outer side surfaces 118 and the outer side surface of the sub-primary coil 102 are the same in distance from the axial line of the primary bobbin 101 in the width direction A. With this configuration, the main primary coil 103 is stably wound with respect to the outer side surface of the sub-primary coil 102 and the second outer side surfaces 118. Further, the sub-primary coil 102 is a single-layer coil. With this configuration, the main primary coil 103 is stably wound with respect to the sub-primary coil 102.

Next, the operation of the ignition coil device 1A is described. First, based on control performed by the main IC 111, a current is supplied to the main primary coil 103. In this manner, an energizing magnetic flux is generated around the main primary coil 103. After that, based on control performed by the main IC 111, the current supply to the main primary coil 103 is stopped. In this manner, an interrupting magnetic flux is generated around the main primary coil 103. As a result, an electromotive force is generated in the secondary coil 105. When the electromotive force is generated in the secondary coil 105, a secondary current flows through the secondary coil 105.

After that, based on control performed by the sub-IC 110, a current is supplied to the sub-primary coil 102. In this manner, a superposing magnetic flux is generated around the sub-primary coil 102. The direction of the superposing magnetic flux is the same as the direction of the interrupting magnetic flux. Therefore, the electromotive force generated in the secondary coil 105 is increased. When the electromotive force generated in the secondary coil 105 is increased, the secondary current flowing through the secondary coil 105 is increased. As a result, large electric energy is supplied to the spark plug.

As described above, according to the ignition coil device 1A of the first embodiment of the present invention, the sub-primary coil 102 is wound around the first outer side surface 117 of the primary bobbin 101 by solid coiling. In this manner, the main primary coil 103 is prevented from entering a space between the wire members forming the sub-primary coil 102. Therefore, the main primary coil 103 is stably wound around the outer side surface of the sub-primary coil 102. In this manner, it is not required to arrange an insulating sheet between the sub-primary coil 102 and the main primary coil 103. As a result, the configuration of the ignition coil device 1A can be simplified.

Further, the sub-primary coil 102 is wound around the first outer side surface 117, and the main primary coil 103 is wound across the second outer side surfaces 118 and the outer side surface of the sub-primary coil 102. When the dimension of the sub-primary coil 102 in the axial direction B is smaller than the dimension of the main primary coil 103 in the axial direction B, the main primary coil 103 can be stably wound around the primary bobbin 101.

Further, the primary bobbin 101 includes the first bobbin portion 114 having the first outer side surface 117, and the second bobbin portions 115 having the second outer side surfaces 118. The dimension of the second bobbin portion 115 in the width direction A is larger than the dimension of the first bobbin portion 114 in the width direction A. In this manner, the primary bobbin 101 can be easily formed, and the movement of the sub-primary coil 102 in the axial direction B can be limited.

Further, the sub-primary coil 102 and the main primary coil 103 are wound in the same direction. In this manner, after the sub-primary coil 102 is wound around the first bobbin portion 114, the main primary coil 103 is successively wound around the second bobbin portions 115 and the sub-primary coil 102. Therefore, the number of processing steps for the ignition coil device 1A can be reduced. Therefore, the manufacturing efficiency of the ignition coil device 1A can be improved.

### Second Embodiment

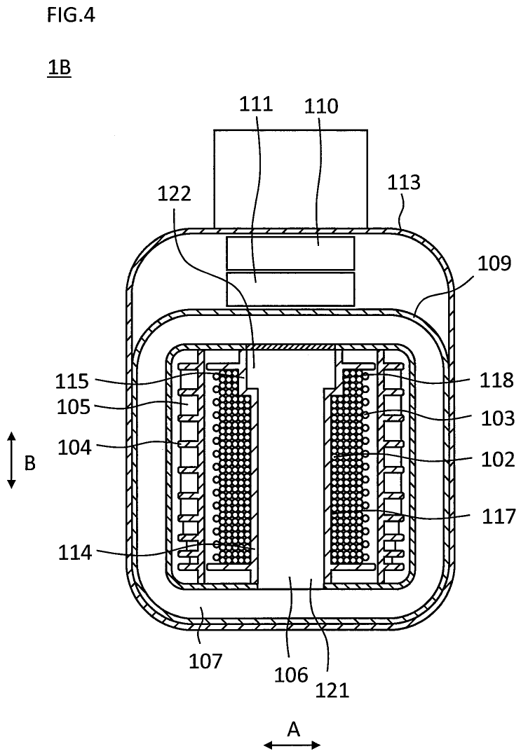

FIG. 4 is a sectional view for illustrating an ignition coil device according to a second embodiment of the present invention. In an ignition coil device 1B, in the axial direction B, the sub-primary coil 102 and the main primary coil 103, and the sub-IC 110 and the main IC 111 are arranged to be adjacent to each other. The sub-primary coil 102 is a two-layer coil. The main primary coil 103 is a four-layer coil.

The ignition coil device 1B includes one second bobbin portion 115. The second bobbin portion 115 is formed adjacent to the first bobbin portion 114 on one side in the axial direction B. Specifically, the second bobbin portion 115 is arranged close to the sub-IC 110 and the main IC 111 in the axial direction B with respect to the first bobbin portion 114.

The center core 106 includes a first center core portion 121 that is adjacent to the first outer side surface 117 in the width direction A, and a second center core portion 122 that is adjacent to the second outer side surface 118 in the width direction A.

The second center core portion 122 is formed adjacent to the first center core portion 121 on one side in the axial direction B. Specifically, the second center core portion 122 is arranged close to the sub-IC 110 and the main IC 111 in the axial direction B with respect to the first center core portion 121. The dimension of the second center core portion 122 in the width direction A is larger than the dimension of the first center core portion 121 in the width direction A. The center core 106 is formed by laminating a plurality of electrical steel sheets.

A winding start part of the sub-primary coil 102 is one side end portion of the sub-primary coil 102 in the axial direction B. Specifically, the winding start part of the sub-primary coil 102 is a part close to the sub-IC 110 of the sub-primary coil 102 in the axial direction B. Meanwhile, a winding end part of the sub-primary coil 102 is the one side end portion of the sub-primary coil 102 in the axial direction B. That is, the winding start part and the winding end part of the sub-primary coil 102 are end portions of the sub-primary coil 102 on the same side in the axial direction B. With this configuration, wiring between the sub-primary coil 102 and the sub-IC 110 can be facilitated.

A winding start part of the main primary coil 103 is one side end portion of the main primary coil 103 in the axial direction B. Specifically, the winding start part of the main primary coil 103 is a part close to the main IC 111 of the main primary coil 103 in the axial direction B. Meanwhile, a winding end part of the main primary coil 103 is the one side end portion of the main primary coil 103 in the axial direction B. That is, the winding start part and the winding end part of the main primary coil 103 are end portions of the main primary coil 103 on the same side in the axial direction B. With this configuration, wiring between the main primary coil 103 and the main IC 111 can be facilitated.

When each of the sub-primary coil 102 and the main primary coil 103 is an even-numbered layer coil, the winding start part and the winding end part of each of the sub-primary coil 102 and the main primary coil 103 are parts on the same side in the axial direction B of each of the sub-primary coil 102 and the main primary coil 103. With this configuration, the orientation of the ignition coil device 1B in the axial direction B can be freely set.

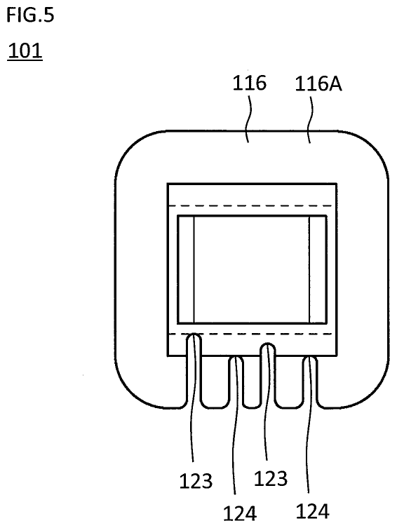

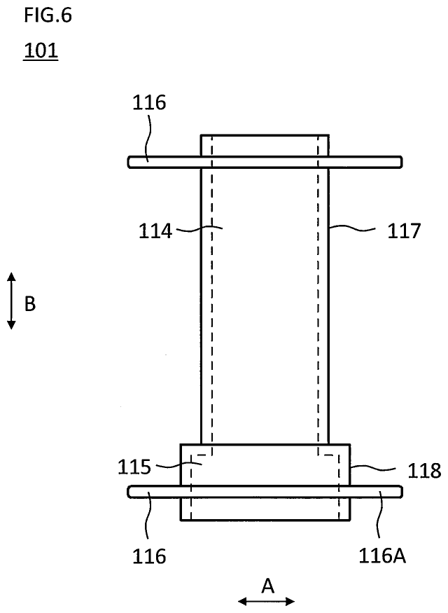

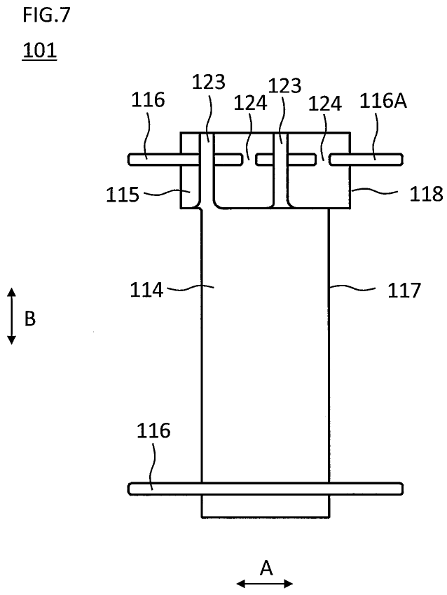

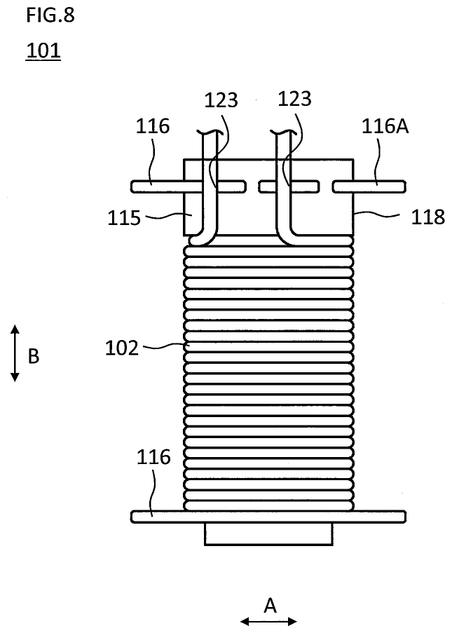

FIG. 5 is a front view for illustrating the primary bobbin 101 illustrated in FIG. 4. FIG. 6 is a plan view for illustrating the primary bobbin 101 illustrated in FIG. 5. FIG. 7 is a bottom view for illustrating the primary bobbin 101 illustrated in FIG. 5. FIG. 8 is a bottom view for illustrating a state in which the sub-primary coil 102 is wound around the primary bobbin 101 illustrated in FIG. 7. One of the pair of flange portions 116 that is arranged closer to the sub-IC 110 and the main IC 111 is referred to as “first flange portion 116A”.

The second outer side surface 118 and the first flange portion 116A have a pair of sub-primary coil insertion grooves 123 serving as first primary coil insertion grooves for allowing both end portions of the sub-primary coil 102 to be inserted therethrough. When both the end portions of the sub-primary coil 102 are inserted through the sub-primary coil insertion grooves 123, in a case in which the main primary coil 103 is wound around the outer side surface of the sub-primary coil 102, both the end portions of the sub-primary coil 102 are prevented from being arranged in a region in which the main primary coil 103 is wound.

The first flange portion 116A has a pair of main primary coil insertion grooves 124 serving as second primary coil insertion grooves for allowing both end portions of the main primary coil 103 to be inserted therethrough. When both the end portions of the main primary coil 103 are inserted through the main primary coil insertion grooves 124, in a case in which the main primary coil 103 is wound around the primary bobbin 101, wiring for connecting between the main primary coil 103 and the main IC 111 can be easily arranged. Other configurations are similar to those of the first embodiment.

As described above, the ignition coil device lB according to the second embodiment of the present invention further includes the center core 106 provided on an inner side with respect to the primary bobbin 101 in the width direction A. The center core 106 includes: the first center core portion 121 provided adjacent to the first outer side surface 117 in the width direction A; and the second center core portion 122 provided adjacent to the second outer side surface 118 in the width direction A. The second center core portion 122 is formed adjacent to the first center core portion 121 in the axial direction B. The dimension of the second center core portion 122 in the width direction A is larger than a dimension of the first center core portion 121 in the width direction A. With this configuration, a region to be occupied by the center core 106 in a region on an inner side with respect to the primary bobbin 101 can be increased. Therefore, the center core 106 can be upsized. As a result, the output of the ignition coil device lB can be increased.

Further, the center core 106 is formed by laminating a plurality of electrical steel sheets. With this configuration, the first center core portion 121 and the second center core portion 122 can be formed by press working. As a result, the center core 106 can be easily manufactured.

Further, the sub-primary coil 102 is a two-layer coil. With this configuration, the winding start part and the winding end part of the sub-primary coil 102 can be parts of the sub-primary coil 102 on the same side in the axial direction B. As a result, the orientation of the ignition coil device lB in the axial direction B can be freely set.

Further, the main primary coil 103 is a four-layer coil. With this configuration, the winding start part and the winding end part of the main primary coil 103 can be parts of the main primary coil 103 on the same side in the axial direction B. As a result, the orientation of the ignition coil device lB in the axial direction B can be freely set.

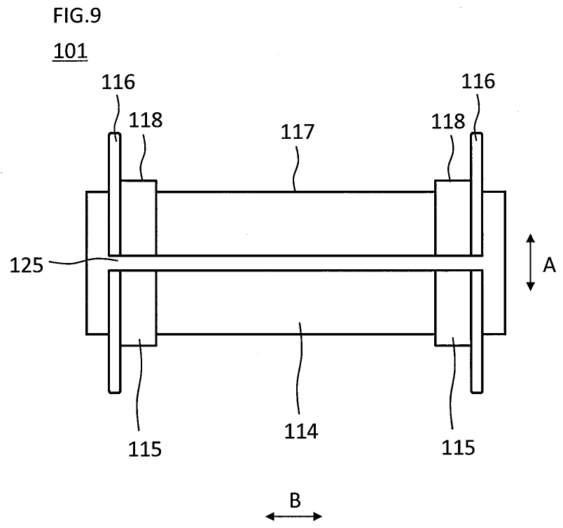

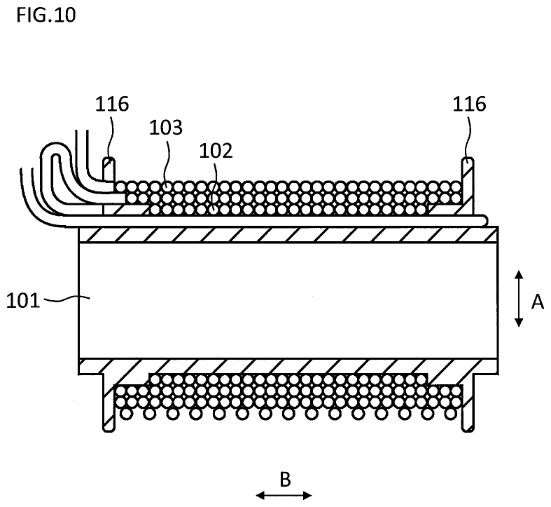

In the second embodiment, description has been given of a configuration in which the sub-primary coil 102 is a two-layer coil. However, the sub-primary coil 102 may be an odd-numbered layer coil. In this case, as illustrated in FIG. 9 and FIG. 10, the first bobbin portion 114, the second bobbin portions 115, and the flange portions 116 may have a sub-primary coil insertion groove 125 for allowing an end portion of the sub-primary coil 102 to be inserted therethrough. In this case, the end portion of the sub-primary coil 102 is inserted through the sub-primary coil insertion groove 125, and then the sub-primary coil 102 is wound around the primary bobbin 101. With this configuration, the winding start part of the sub-primary coil 102 and the winding end part of the sub-primary coil 102 can be parts of the sub-primary coil 102 on the same side in the axial direction B.

Further, in the second embodiment, description has been given of a configuration in which the main primary coil 103 is a four-layer coil. However, the main primary coil 103 may be an even-numbered layer coil other than a four-layer coil.

Further, in the second embodiment, description has been given of the center core 106 formed of a plurality of laminated electrical steel sheets. However, for example, the center core 106 may be formed of a sintered core.

Further, in the second embodiment, description has been given of a configuration of the center core 106 in which the second center core portion 122 is arranged closer to the sub-IC 110 and the main IC 111 with respect to the first center core portion 121 in the axial direction B. However, the center core 106 may have a configuration in which a pair of second center core portions 122 are arranged so as to sandwich the first center core portion 121 in the axial direction B. Further, the center core 106 may have a configuration in which the second center core portion 122 is arranged so as to be separated away from the sub-IC 110 and the main IC 111 with respect to the first center core portion 121 in the axial direction B.

Further, in the embodiments, description has been given of a configuration in which the sub-primary coil 102 and the main primary coil 103 are wound in the same direction in the circumferential direction of the primary bobbin 101. However, the sub-primary coil 102 and the main primary coil 103 may be wound in directions different from each other in the circumferential direction of the primary bobbin 101. In this case, the sub-primary coil 102 and the main primary coil 103 are connected to the connection terminal 112 so that the direction of the current flowing through the sub-primary coil 102 and the direction of the current flowing through the main primary coil 103 differ from each other.

Further, in the embodiments, description has been given of a configuration in which the first primary coil is the sub-primary coil 102, and the second primary coil is the main primary coil 103. In other words, in the embodiments, description has been given of a configuration in which the sub-primary coil 102 is wound around the first outer side surface 117, and the main primary coil 103 is wound across the second outer side surface 118 and the outer side surface of the sub-primary coil 102. However, there may be employed a configuration in which the main primary coil 103 is wound around the first outer side surface 117, and the sub-primary coil 102 is wound across the second outer side surface 118 and the outer side surface of the main primary coil 103. In other words, there may be employed a configuration in which the first primary coil is the main primary coil 103, and the second primary coil is the sub-primary coil 102.

What is claimed is:

1. An ignition coil device, comprising:
a primary bobbin having a first outer side surface and a second outer side surface formed on an outer side with respect to the first outer side surface in a width direction of the ignition coil device;
a first primary coil wound around the first outer side surface; and
a second primary coil wound across the second outer side surface and an outer side surface of the first primary coil,
the first primary coil being formed by solid coiling.

2. The ignition coil device according to claim 1,
wherein the primary bobbin includes:
a first bobbin portion having the first outer side surface; and
a second bobbin portion having the second outer side surface and being formed adjacent to the first bobbin portion in an axial direction of the ignition coil device, and
wherein a dimension of the second bobbin portion in the width direction is larger than a dimension of the first bobbin portion in the width direction.

3. The ignition coil device according to claim 1, further comprising a center core provided on an inner side with respect to the primary bobbin in the width direction,
wherein the center core includes:
a first center core portion provided adjacent to the first outer side surface in the width direction; and
a second center core portion provided adjacent to the second outer side surface in the width direction,
wherein the second center core portion is formed adjacent to the first center core portion in the axial direction, and
wherein a dimension of the second center core portion in the width direction is larger than a dimension of the first center core portion in the width direction.

4. The ignition coil device according to claim 3, wherein the center core is formed by laminating a plurality of electrical steel sheets.

5. The ignition coil device according to claim 1, wherein the first primary coil and the second primary coil are wound in the same direction.

6. The ignition coil device according to claim 1,
wherein the first primary coil is a sub-primary coil, and
wherein the second primary coil is a main primary coil.

7. The ignition coil device according to claim 1, wherein the first primary coil is a single-layer coil.

8. The ignition coil device according to claim 1, wherein the second primary coil is an even-numbered layer coil.
